(19) United States
(12) Patent Application Publication
(10) Pub. No.: US 2011/0143064 A1
(43) Pub. Date: Jun. 16, 2011

(54) COMPOSITION FOR REINFORCING HOLLOW GLASS AND PROTECTING SAME FROM SCRATCHING, CORRESPONDING TREATMENT METHODS AND RESULTING TREATED HOLLOW GLASS

(75) Inventors: Claude Da Silva, Aulnay Sous Bois (FR); Stephane Lohou, Paris (FR); Jean-Baptiste Denis, Bois Colombes (FR)

(73) Assignee: SAINT-GOBAIN EMBALLAGE, Courbevoie (FR)

(21) Appl. No.: 13/003,477

(22) PCT Filed: Jul. 8, 2009
(86) PCT No.: PCT/FR09/51349

§ 371 Date: Mar. 2, 2011

(30) Foreign Application Priority Data
Jul. 9, 2008 (FR) 085663

(51) Int. Cl. B32B 1/02; C09D 163/02; B05D 3/02; C03C 17/28; C03B 25/00; C03B 9/00

(52) U.S. Cl. 428/34.7; 523/425; 523/421; 427/386; 427/287; 65/60.3

(57) ABSTRACT

This composition comprises, in water:
(A) at least one adhesion promoter bearing at least one amine functional group and/or at least one epoxy functional group;
(B) at least one monomer and/or at least one prepolymer intended to form a polymer system capable of reacting covalently with the amine and/or epoxy functional group(s) of the constituent (A);
(C) at least one curing agent or crosslinker used in an amount equivalent to ±30 mol % of the stoichiometry of the constituent (B);
   the constituent (B) being present in the composition in an amount of 0.5 to 5% by weight, in particular in an amount of 1.5% by weight, expressed as solids in water; and
   the constituent (A) being present in an amount of 0.2 to 3 parts by weight per 100 parts by weight of the constituent (B).

The present invention relates to the conditioning of hollow glass after the forming thereof in order to reinforce it and protect it against scratching.

The expression “hollow glass” is understood to mean the glasses made in order to constitute containers, such as bottles, flasks, pots, etc.

The process for manufacturing and conditioning hollow glass comprises the following operations:
forming the hollow glass at a temperature of around 700° C.;
surface treatment referred to as “hot treatment”, the surface temperature of the hollow glass then being of the order of 500° C.-600° C.;
annealing the hollow glass;
surface treatment referred to as “cold treatment”, the surface temperature of the hollow glass being of the order of 80° C.-150° C.

The molded hollow glass resulting from the forming is placed on a conveyor and then passes to the hot surface treatment station, this treatment consisting in applying to the glass, by chemical vapor deposition (CVD), a layer of SnO₂ or of TiO₂ over a thickness of the order to 10-20 nm. This layer has the double role, on the one hand, of an agent for protecting the glass against defects which may be created by contacts at high temperature and, on the other hand, of a bonding primer for the cold surface treatment which will follow.

The molded and thus hot-treated hollow glass then passes into an annealing lehr where it is annealed at a temperature of 500° C.-600° C. depending on the type of glass and exits at around 150° C., then is sent, still on its conveyor, to the cold surface treatment station, during which, deposited on this hollow glass, by spraying, is at least one agent for protection against scratches and the rubbing actions from use and from handling. This agent, which has lubricating properties, is generally chosen from waxes, such as oxidized or non-oxidized polyethylene waxes, partial esters of fatty acids and fatty acids, and polyurethanes and other polymers known for their protective role, such as acrylic polymers.

This hollow glass is intended to subsequently be subjected to a great many handling operations: palletizing, transportation, depalletizing, filling bottles, flasks, etc., capping, labeling, transportation, etc.

For all these reasons, in order for the consumer to be able to receive defect-free containers, a conditioning is sought for the hollow glass after the forming thereof that has the double role of reinforcing it and of protecting it:
the reinforcement aims to increase the intrinsic mechanical strength of the glass, that is to say to increase the fracture stress of the glass so that it withstands the internal pressure and in order to limit the appearance of new defects linked to scratching and to limit the loss of mechanical strength which inevitably occurs during the service life;
the protection aims to lubricate the surface of the glass, limiting abrasion and the appearance of scratches and consequently the appearance of new surface defects.

The mechanical properties of glass packagings are limited, in particular, by surface defects related to the forming and, more generally, to all high-temperature contacts in the production cycle. Unfortunately, these defects cannot be avoided: contact with the mold already takes place when the parison falls into this mold and, under the effect of heat shocks, cooling operations, traces of lubricant from the molds, etc., stresses appear in the glass and cracks, inclusions of batch stones, etc., appear at the surface thereof, which are the source of the defects that it is desired to avoid.

The first aforementioned surface treatment (by CVD) provides protection for the glass just after the forming thereof and before it enters into the annealing lehr. The second surface treatment (by spraying waxes or the like) is necessary to supplement the first treatment and to limit the appearance of new surface defects on the glass following this treatment. Such treatments do not, however, provide the reinforcement of the glass. They settle for protecting the surface by limiting the propagation of cracks.

Various reinforcement treatments have been studied but none has proved to be able to be used industrially. Indeed, these treatments consist of the application of resins, which can only be applied at ambient temperature, whereas it is advantageous to be able to carry out such a treatment on the glass at 80-150° C. instead of the second aforementioned surface treatment in order not to needlessly complicate or lengthen the manufacturing line. Furthermore, with such treatments, the scratch resistance is insufficient.

Also known from WO 2006/013305 A1 are compositions for the surface treatment of hollow glass, presented as being able to be applied at a temperature of 10-150° C. Such compositions in fact mainly provide only a healing of the surface defects.

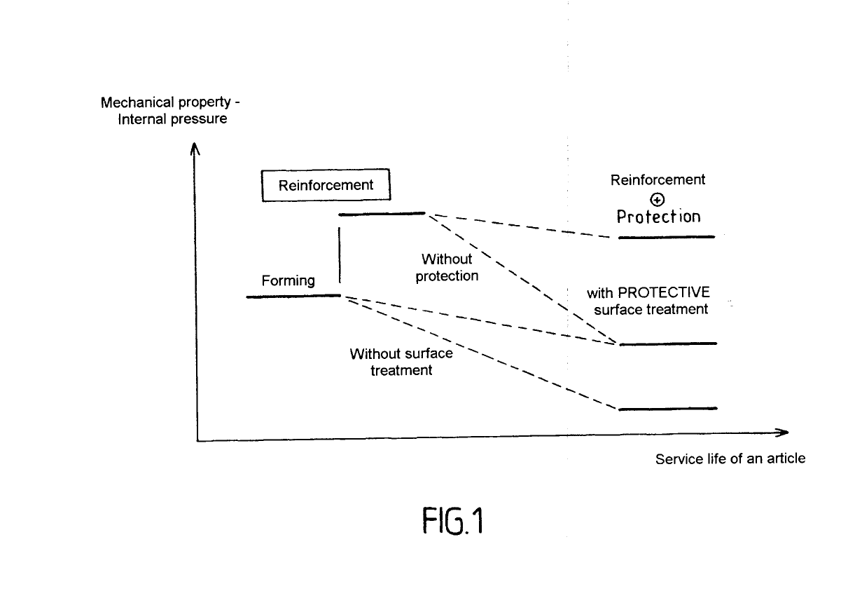

Reference may be made to FIG. 1 of the appended drawing which schematically illustrates the change in the mechanical strength throughout the service life of a hollow glass depending on whether or not it has undergone, after the forming thereof, a reinforcement treatment and, in each case, a surface protection treatment or any surface protection treatment.

The problem faced is therefore to find a treatment of the hollow glass that provides reinforcement and, at the same time, surface protection, advantageously that can be deposited on hot glass at 80-150° C. It would furthermore be advantageous to be able to do away with the CVD treatment, in other words that the treatment proposed can simultaneously provide the healing of the cracks and defects that have appeared previously, namely during the forming and during the annealing.

The objective of the present invention is to provide a solution to these problems.

One subject of the present invention is therefore firstly the use, as agent having the double role of reinforcing the hollow glass and of protecting it against scratches, of at least one glass adhesion promoter comprising at least one amine functional group and/or at least one epoxy functional group which has reacted covalently with a polymer system formed from at least one monomer and/or at least one prepolymer and of at least one curing agent or crosslinker used in an amount equivalent or substantially equivalent to the stoichiometry of the monomer(s) and/or prepolymer(s).

Another subject of the present invention is a composition for treating the surface of a hollow glass, characterized by the fact that it comprises, in water:
(A) at least one adhesion promoter bearing at least one amine functional group and/or at least one epoxy functional group;
(B) at least one monomer and/or at least one prepolymer intended to form a polymer system capable of reacting covalently with the amine and/or epoxy functional group(s) of the constituent (A);
(C) at least one curing agent or crosslinker used in an amount equivalent to ±30 mol % of the stoichiometry of the constituent (B);
   the constituent (B) being present in the composition in an amount of 0.5 to 5% by weight, in particular in an amount of 1.5% by weight, expressed as solids in water; and
   the constituent (A) being present in an amount of 0.2 to 3 parts by weight per 100 parts by weight of the constituent (B).

### Constituent (A): Adhesion Promoter or Coupling Agent

The constituent (A) is advantageously present in an amount of 0.5 to 2 parts by weight per 100 parts by weight of the constituent (B).

It is especially chosen from aminosilanes, aminodisilanes, epoxysilanes and organometallic adhesion promoters having at least one —NH— and/or —NH₂ functional group.

In particular, the constituent (A) is chosen from the silanes of formulae (I) and (II):

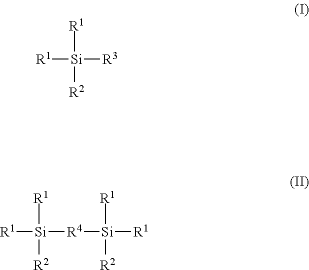

in which:

R¹ represents methoxy or ethoxy;

R² represents R¹ or methyl;
R³ represents a monovalent hydrocarbon radical comprising at least one —NH— and/or —NH₂ functional group, in particular from 1 to 3—NH— and/or —NH₂ functional groups, or an epoxy functional group;
R⁴ represents a divalent hydrocarbon radical comprising at least one —NH— and/or —NH₂ functional group, in particular from 1 to 3—NH— and/or —NH₂ functional groups.

When R³ bears at least one amino functional group, it may be constituted by an alkyl or aralkyl radical, the aryl group of which is, where appropriate, substituted by vinyl, cycloalkylalkyl or aryl. When R³ bears an epoxy (glycidoxy) functional group, it may be constituted by an alkyl radical, the epoxy group being borne by the two terminal carbons of the alkyl radical, or by a cycloalkylalkyl radical, the epoxy group being borne by two neighboring carbons of the cycloalkyl group and the alkyl parts possibly being interrupted by an oxygen atom.

R⁴ is especially a divalent alkylene residue.

In particular, the constituent (A) may be chosen from:
aminosilanes, such as 3-(triethoxy-silyl)propylamine, 3-(trimethoxysilyl)propylamine, 3-(diethoxymethylsilyl)propylamine, N-[3-(tri-methoxysilyl)propyl]aniline, N-[3-(trimethoxy-silyl)propyl]ethylenediamine, N-[3-(triethoxy-silyl)propyl]ethylenediamine, N-[3-(triethoxy-silyl)propyl]ethylenediamine, N-[3-(dimethoxy-methylsilyl)-2-methylpropyl]ethylenediamine, N-(2-aminoethyl)-N′-[3-(trimethoxysilyl)propyl]ethylene-diamine, N-[3-(trimethoxysilyl)propyl]-N′-(vinylbenzyl)ethylenediamine, and its hydrochlorides, [3-(triethoxysilyl)propyl]urea and m-aminophenyltrimethoxysilane;
aminodisilanes, such as bis(triethoxysilyl-propyl)amine and bis(trimethoxysilylpropyl)amine;
epoxysilanes, such as [3-(2,3-epoxy-propoxy)propyl]trimethoxysilane, [3-(2,3-epoxy-propoxy)propyl]triethoxysilane, [3-(2,3-epoxy-propoxy)propyl]dimethoxymethylsilane, [3-(2,3-epoxypropoxy)propyl]diethoxymethylsilane and [2-(3,4-epoxycyclohexyl)ethyl]trimethoxysilane.

It is preferred that the amino(di)silanes and the epoxysilanes are introduced into the composition in the hydrolyzed state.

The constituent (A) may also be chosen from coupling agents of amino zircoaluminate type, such as zirconium, β-alanine chloro hydroxy propylene glycol aluminum complexes. Mention may be made of the amino zircoaluminate complexes at 20 to 40% by weight in a solvent medium sold under the trade name CAVCO GLAS™ APG products by McGean, represented by the formula (III):

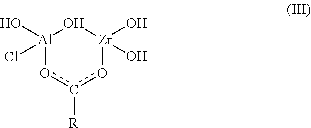

in which R is a hydrocarbon radical having an amino functional group.

Mention may also be made, as other metallic adhesion promoters, of the coupling agents sold under the names Chartwell B515.5W and Chartwell B516.5W by Chartwell, respectively having one amino group and two amino groups.

Constituent (B): Monomer(s) and/or Prepolymer(s) of the Polymer System

The constituent (B) is especially chosen from derivatives of bisphenol A, such as those represented by the formula (IV):

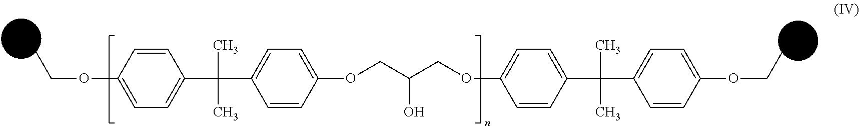

in which n is between 0 and 5, the limits included, derivatives of bisphenol F and epoxy novolacs, such as those represented by the formula (V):

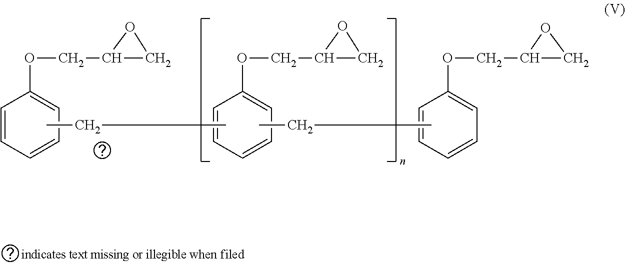

in which n is the number of repeat units, having an average value of 0 to 2.

The constituent (B) may be any type of epoxide emulsion. It has been noted that the scratch resistance increases with the increase in the length of the epoxy monomer or prepolymer used as constituent (B).

### Constituent (C): Curing Agent or Crosslinker for the Polymer System

The constituent (C) is advantageously used in an amount equivalent to the stoichiometry of the constituent (B) or to ±10 mol % of the stoichiometry of the constituent (B). It may especially be chosen from:
dicyandiamide, represented by the formula

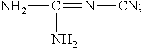

melamine (which would, however, require a firing of the glass at 260° C.)
water-soluble aliphatic amines, such as ethylenediamine, diethylenetriamine, triethylene-tetramine, tetraethylenepentamine, which are of food quality but which do not function if the deposition of the composition on the glass is carried out at more than 80° C.;
polyetheramines—which are not of food quality—such as those of the Jeffamine® D and ED series represented by the formulae (VI) and (VII) respectively:

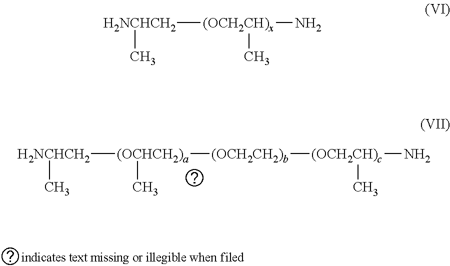

As Jeffamines from the D series, mention may be made of the Jeffamines D-230 (x=2-3), D-400 (x=5-6), D-2000 (x=33 on average) and D-4000 (x=68 on average) and, as Jeffamines from the ED series, the Jeffamines HK-511 (XTJ-511) (b=2.0 and a+c=2.0), XTJ-500 (ED-600) (b=9.0 and a+c=3.6) and XTJ-502 (ED-2003) (b=38.7 and a+c=6.0).

In the case where the constituent (C) is the dicyandiamide, it is especially present in an amount of 5 to 10 parts by weight, in particular of 6 to 7 parts by weight, of the constituent (B).

The dicyandiamide which is used in the case of a 4 minute firing of the glass at 200° C. with the “K54” catalyst mentioned below is preferred.

### Constituent (D): Catalyst

The constituent (D) is advantageously present, especially, in an amount of 0.1 to 2 parts by weight, especially of 0.5 part by weight, per 100 parts by weight of the constituent (B). It may especially be chosen from:
tertiary amines, such as 2,4,6-tri(di-methylaminomethyl)phenol (Ancamine K54 from Air Products) and the 2-ethylhexanoic salt of 2,4,6-tri(dimethylaminomethyl)phenol (K61B from the same company); and
imidazoles, such as those sold under the names Imicure® AMI-2, Curezol® 2E4MZ, Curezol® 1B2MZ, Curezol® 2PZ, Curezol® 2P4MZ and Curezol® C17Z, respectively of formulae:

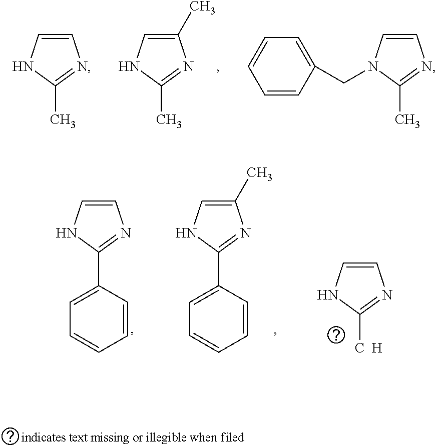

Constituent (E): Agent that Improves the Bonding of Labels, in Particular with Aqueous Starch and Casein Adhesives

The optional constituent (E) may advantageously represent from 0.02 to 0.5% by weight, in particular from 0.05 to 0.2% by weight, expressed as solids in water, in the total composition.

It may especially be sodium dodecyl sulfate, which is effective in particular when use is made, as constituent (B), of an Epirez epoxide emulsion from Hexion from which a portion (for example half) of the surfactant has been removed.

### Processes and Hollow Glasses Obtained

The present invention also relates to a process for treating the surface of a hollow glass in order to reinforce it and to protect it against scratching, characterized by the fact that a thin film of the composition as defined above is applied to the glass parts to be treated, and that the polymer system is formed and reacted with the adhesion promoter under the action of heat with removal of the aqueous carrier, leaving on the glass a layer, which may be discontinuous, of the reinforcing and anti-scratch agent.

Advantageously, it is possible to apply the thin film of the composition, by spraying, at a temperature of 80 to 200° C.

The invention also relates to a process for manufacturing and conditioning a hollow glass, characterized by the fact that the following operations are carried out:
(a) forming the hollow glass at a temperature of 700-800° C.;
(b) annealing the hollow glass in an annealing lehr at a temperature of 500° C.-600° C. depending on the type of glass;
(c) surface treatment via the process as defined

above,

the hollow glass formed being conveyed continuously, passing through the annealing lehr and then to a station where it is subjected to the surface treatment (c).

In accordance with a first particularly preferred embodiment, the hollow glass is sent from the forming directly to the annealing step. Thus, the aforementioned step of applying SnO₂ or TiO₂ via CVD is dispensed with, hollow glasses that have very good mechanical strength with a scratch resistance that is still acceptable being obtained.

In accordance with a second embodiment, the hollow glass is sent to a step of surface treatment with SnO₂ or TiO₂ applied by CVD before being sent to the annealing step.

The present invention also relates to a hollow glass treated by a composition as defined above, according to the process as defined above.

In particular, the cured composition deposited on the glass may have an average thickness of less than 100 nm, in particular of less than 50 nm, preferably of less than 10 nm. However, the average thickness of the composition may also be greater than 100 nm.

The present invention finally relates to the use of a composition as defined above for reinforcing the hollow glass and for protecting it against scratching.

The following examples illustrate the present invention without, however, limiting the scope thereof. In these examples, the parts and percentages are by weight, unless otherwise indicated.

### EXAMPLES 1 TO 3

The following three formulations were prepared:

% by weight in water (per 100 parts of epoxy resin)

| | Example 1 | Example 2 | Example 3 |
|---|---|---|---|
| Silane A 1100 | 0.0075% | — | 0.0075% |
| | (0.57) | | (0.23) |
| Silane A 187 | — | 0.0075% | — |
| | | (0.57) | |
| Epoxy resin 1 | 1.32% | 1.32% | — |
| Epoxy resin 2 | — | — | 3.3% |
| Dicyandiamide | 0.09% | 0.09% | 0.09% |
| | (6.8) | (6.8) | (2.7) |
| Catalyst | 0.0075% | 0.0075% | 0.008% |
| | (0.57) | (0.57) | (0.23) |

In these formulations:
the silane A1100 is 3-(triethoxysilyl)propylamine;
the silane A187 is [3-(2,3-epoxypropoxy)propyl]trimethoxysilane;
the epoxy resin No. 1 is the epoxy resin sold under the trade mark EPIREZ 3510W60 by Hexion, which is an aqueous emulsion of bisphenol A diglycidyl ether (BADGE), the average molar mass of which is of the order of 370 g/mol and which is represented by the formula (III) above for which n=0.1;
the epoxy resin No. 2 is the epoxy resin sold under the trade mark EPIREZ 3520WY55 by Hexion, which is an aqueous emulsion of bisphenol A diglycidyl ether (BADGE), the average molar mass of which is of the order of 910 g/mol and which is represented by the formula (III) above for which n=2;
the catalyst is the 2,4,6-tri(dimethylaminomethyl)phenol sold under the name Ancamine K54.

The coating is deposited by spraying onto flat glass having dimensions of 70×70 mm and a thickness of 3.85 mm, previously indented at 50 N for 20 s by a Vickers tip. These samples were brought to 120° C. in an oven before deposition. The coated samples then underwent curing in an oven for 5 minutes at 220° C. The mechanical strength of the plates is tested by a three-point bending test, at a crosshead speed of 5 mm/s. The “controls” correspond to the case of the untreated indented glass.

The fracture stresses listed in table 1 correspond to an average value out of 10 plates tested.

TABLE 1

| Sample | Control | Example 1 | Example 2 | Example 3 |
|---|---|---|---|---|
| Average | 36.4 | 78.6 | 75.3 | 68.2 |
| fracture stress | | | | |
| (MPa) | | | | |

### EXAMPLE 4

### Effect of the Compositions of the Invention on the Overall Mechanical Strength of Articles Made of Hollow Glass

Spraying tests were carried out on 300 g Burgundy bottles on an industrial line. After the spray booms, the treated bottles were recovered on the belt and deposited in two ovens at the edge of the line for crosslinking the coating. This was carried out at 220° C. (oven setpoint) for 20 minutes. These conditions are deliberately high so as to exclude any crosslinking defect and to focus the study on the effectiveness of the spray conditions.

The composition of the formulations used in tests 1 and 2 is that of example 1, described in table 1.

The spray parameters are described in table 2 below:

TABLE 2
Spray conditions and number of articles sampled

| | | | | Number |
|---|---|---|---|---|
| | | | Concentration | of |
| | PA* flow | PST** | of active | articles |
| | rate | flow rate | material | sampled |
| Controls | 4 × 10 l/h | 2 × 4 l/h | 1.5% | 210 |
| Test 1 | 4 × 10 l/h | 2 × 6 l/h | 1.3% | 200 |
| Test 2 | 4 × 11 l/h | 2 × 12 l/h | 2% | 230 |

*PA: overhead spraying, 4 spray guns;
**PST: under belt spraying, 2 spray guns.

The controls received a cold surface treatment based on modified polyethylene wax. Such a treatment does not exhibit any reinforcing power regardless of the amount deposited.

The characterization via internal pressure (IP) was carried out in situ, on 10 to 12 articles per mold (on 16 molds, 14 molds for test 1).

The appearance of the articles is good, under the two test conditions, comparable to the controls.

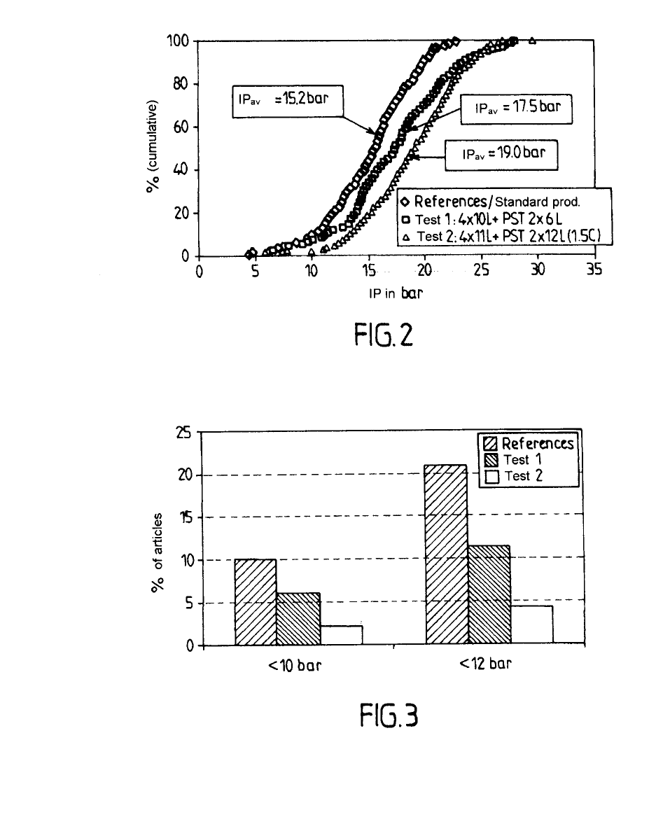

The effect of the reinforcing treatment according to the invention on the distribution of internal pressure is represented in FIG. 2. An increase of 25% in the average internal pressure is noted in the case of test 2 compared with the controls.

The effect of the reinforcing treatment according to the invention on the number of low values of resistance to the internal pressure (below 10 and 12 bar) is represented in FIG. 3. The percentage of articles below 10 bar changes from 10% for the controls to 2.1% under the conditions of test 2. The number of articles below 10 and 12 bar is reduced by a factor of 5 in the case of test 2 compared with the controls.

### EXAMPLE 5

### Reinforcement Via the Treatment According to the Invention on Articles without Hot-End Treatment

The bottles are sampled after the annealing lehr and then treated with the composition from example 1 of the invention by cold spraying, the hot-end treatment tunnel having been stopped. The control articles are sampled with and without hot treatment in order to evaluate the loss of mechanical properties after passing through the annealing lehr without the SnO₂ layer. The articles without SnO₂ were sampled just after cleaning the hot treatment tunnel. After treatment, the bottles are broken in the internal pressure test. The location of the source of fracture was noted and all the bottles that broke below 15 bar were analyzed.

The bottles were sampled in groups of 32 molds before the cold-end treatment. For each treatment, 5×32 bottles were sampled, i.e. a total of 480 bottles. The articles considered as controls are the articles treated at high temperature (SnO₂) and at low temperature with a polyethylene wax in line.

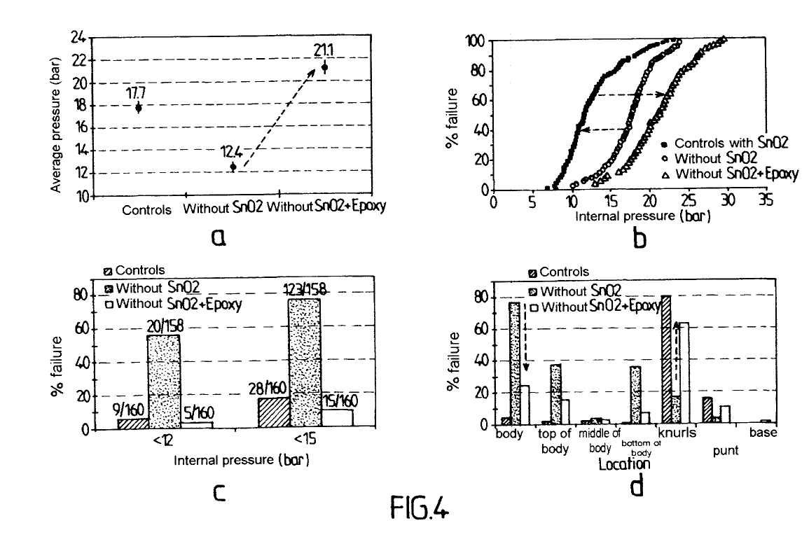

The results are reported in FIG. 4:

FIG. 4a: average of the pressures

FIG. 4b: cumulative percentage of fracture as a function of the internal pressure

FIG. 4c: percentage of fractures at low values; and

FIG. 4d: distribution of the location of the sources of fracture (all pressures merged).

A very great reduction in the internal pressure (of the order of 5 bar) is observed for the articles without SnO₂ sampled at the outlet of the annealing lehr, compared with the articles with SnO₂ (FIG. 4a). This result demonstrates the protective role of the SnO₂ layer between the hot treatment tunnel and the cold-end treatment line located at the outlet of the annealing lehr, this protective effect being quantified here.

The application of the coating according to the invention allows a great increase (8.7 bar) in the average internal pressure level, thus making it possible not only to compensate for this loss of mechanical strength in the absence of SnO₂ but even to be at an average internal pressure level equivalent to the articles with SnO₂.

If the relative gain in mechanical strength is considered, the coating according to the invention therefore appears significantly more effective in the absence of SnO₂ layer.

The effect on the reduction in low levels (below 12 bar) is spectacular, with a change from 55% for the articles without SnO₂ to 3% after treatment according to the invention (FIG. 4c).

The elimination of very low levels (FIG. 4b) is also noted: 42 values out of 160 below 10 bar without SnO₂, versus none after treatment (the lowest value is 10.1 bar).

1. A method reinforcing hollow glass and protecting hollow glass against scratches, the method comprising:
applying to a surface of the hollow glass, an agent comprising
at least one glass adhesion promoter comprising at least one amine or epoxy functional group which has reacted covalently with a polymer system formed from at least one monomer and/or at least one prepolymer, and
at least one curing agent or crosslinker in an amount equivalent or substantially equivalent to a stoichiometry of the at least one monomer and/or prepolymer.

2. A composition, comprising, in water:
(A) at least one adhesion promoter bearing at least one amine functional group and/or at least one epoxy functional group;
(B) at least one monomer and/or at least one prepolymer which forms a polymer system capable of reacting covalently with the amine and/or epoxy functional group(s) of the constituent (A);
(C) at least one curing agent or crosslinker in an amount equivalent to ±30 mol % of a stoichiometry of the constituent (B);
wherein the constituent (B) is present in the composition in an amount of 0.5 to 5% by weight, expressed as solids in water; and
the constituent (A) is present in an amount of 0.2 to 3 parts by weight per 100 parts by weight of the constituent (B).

3. The composition of claim 2, wherein the constituent (A) is present in an amount of 0.5 to 2 parts by weight per 100 parts by weight of the constituent (B).

4. The composition of claim 2, wherein the constituent (A) is selected from the group consisting of an aminosilane, an aminodisilane, an epoxysilane, and an organometallic adhesion promoter bearing at least one —NH₂ and/or —NH— functional group.

5. The composition of claim 2, wherein the constituent (A) is selected from the group consisting of compounds of formulae (I) and (II): 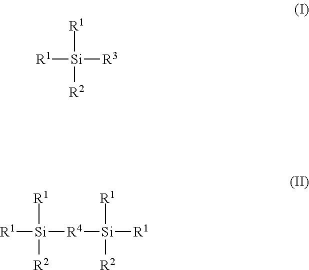
wherein:
R¹ represents methoxy or ethoxy;
R² represents R¹ or methyl;
R³ represents a monovalent hydrocarbon residue comprising at least one —NH— and/or —NH₂ functional group, or an epoxy functional group;
R⁴ represents a divalent hydrocarbon residue comprising at least one —NH— and/or —NH₂ functional group.

6. The composition of claim 2, wherein the constituent (A) is an amino zircoaluminate coupling agents.

7. The composition of claim 2, the constituent (B) is selected from the group consisting of
a derivative of bisphenol A, represented by formula (IV): 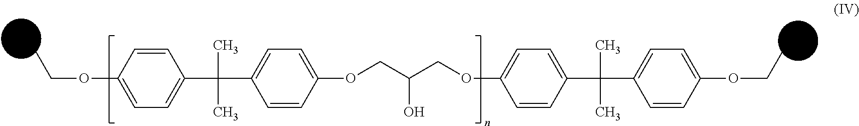
wherein n is between 0 and 5, the limits included,
a derivative of bisphenol F and an epoxy novolac represented by formula (V): 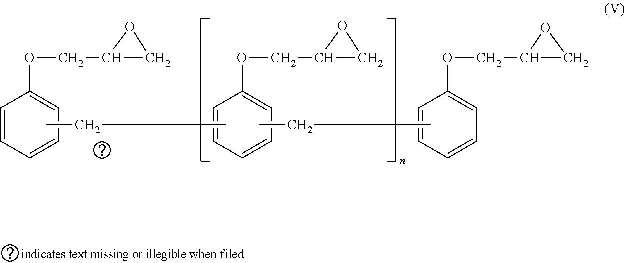
wherein n is the number of repeat units, having an average value of 0 to 2, and
an epoxide emulsion.

8. The composition of claim 2, wherein characterized by the fact that the constituent (C) is employed in an amount equivalent to the stoichiometry of the constituent (B) or to ±10 mol % of the stoichiometry of the constituent (B).

9. The composition of claim 2, wherein the constituent (C) is selected from the group consisting of:
a dicyandiamide;
a melamine;
a water-soluble aliphatic amine; and
a polyetheramine.

10. The composition of claim 2, wherein the constituent (C) is dicyandiamide, being present in an amount of 5 to 10 parts by weight, of the constituent (B).

11. The composition of claim 2, further comprising:
(D) at least one catalyst for curing or crosslinking the polymer system, in an amount of 0.1 to 2 parts by weight per 100 parts by weight of the constituent (B).

12. The composition of claim 11, wherein the constituent (D) is selected from the group consisting of:
a tertiary amine; and
an imidazole.

13. The composition of claim 2, further comprising:
(E) at least one agent that promotes a subsequent bonding of labels to the hollow glass, in an amount of 0.02 to 0.5% by weight, expressed as solids in water, in the total composition.

14. The composition of claim 13, wherein the constituent (E) is sodium dodecyl sulfate.

15. A process for treating a surface of a hollow glass in order to reinforce it and to protect it against scratching, the process comprising:
applying a thin film of the composition of claim 2 to glass parts to be treated; and
forming the polymer system and reacting the polymer system with the adhesion promoter under the action of heat with removal of any aqueous carrier, leaving on the glass a layer, which is optionally discontinuous, of the reinforcing and anti-scratch agent.

16. The process as claimed in claim 15, wherein the thin film of the composition is applied, by spraying, at a temperature of 80 to 200° C.

17. A process for manufacturing and conditioning a hollow glass, the processing comprising
(a) forming the hollow glass at a temperature of 700-800° C.;
(b) annealing the hollow glass in an annealing lehr at a temperature of 500° C.-600° C.
(c) surface treating via the process of claim 15,
wherein the hollow glass which is formed is conveyed continuously, passing through the annealing lehr and then to a station where it is subjected to the surface treating (c).

18. The process of claim 17, wherein the hollow glass is sent from the forming (a) directly to the annealing (b).

19. The process of claim 17, wherein the hollow glass is sent to a surface treating with SnO₂ or TiO₂, applied by CVD, before being sent to the annealing (b).

20. A hollow glass, treated by the process of claim 15.

21. The hollow glass of claim 20, wherein the layer deposited on the glass has an average thickness of less than 100 nm.

22. (canceled)
